(19) United States
(12) Patent Application Publication
(10) Pub. No.: US 2025/0199586 A1
(43) Pub. Date: Jun. 19, 2025

(54) METHOD AND SYSTEM FOR ENHANCING SHOPPING EXPERIENCE WITH CART-BASED SHOPPING AID DEVICES

(71) Applicant: Bryan Crum, Mount Washington, KY (US)

(72) Inventor: Bryan Crum, Mount Washington, KY (US)

(21) Appl. No.: 18/940,686

(22) Filed: Nov. 7, 2024

Related U.S. Application Data
(60) Provisional application No. 63/596,830, filed on Nov. 7, 2023.

(51) Int. Cl. G06F 1/16; B62B 3/14

(52) U.S. Cl. CPC G06F 1/1656; B62B 3/1424

(57) ABSTRACT

A kiosk houses and charges a set of rechargeable cart-deployed communications and display devices (CCDDs) for use in shopping. The CCDDs are locked on shopping carts and at the kiosk to prevent unwanted theft and damage and are released by a key. The mechanical key may operate as a typical mechanical key with the CCDDs having a key receiving slot or opening or feature such that the key acts on a matingly configured locking/unlocking mechanism to dislodge the locking/unlocking mechanism and allow the CCDD to be removable from the kiosk and securely placed on a receiving CCDD support platform installed on the cart. The mechanical key may have a transponder or similar “handshaking” feature to provide a level of authentication or identification that the key is an authorized key for purposes of removing CCDDs.

### FIELD OF THE INVENTION

The invention generally relates to the field of systems for enhancing shopping experience in brick-and-mortar retail stores.

### BACKGROUND OF THE INVENTION

Retailers, for example grocery store retailers, are always looking for ways to gain competitive advantages over competitors and also ways to promote and maintain customer loyalty, which go hand-in-hand. Customers are increasingly looking for enhanced shopping experiences including in the form of greater information, better access to such information, and more relevant information.

What is needed is a system that promotes shopper loyalty and brand identity and enhances shopper experience.

There are known systems that provide shopping aids for use on shopping carts with kiosks or walls for storing the shopping aids for customer use. However, such shopping aids are typically large in size and the kiosk or wall associated with such aids take up excessive space in the store, where hundreds of shoppers may be engaged in shopping at any given time and thus the footprint required to store and distribute one hundred or more shopping aids at any given time is prohibitively large or is at least undesired. Such systems typically are not secured at either or both of the kiosk or wall storage or on the shopping cart. Although electro-magnetic wheel locks or the like may be placed on carts to prevent unwanted removal of shopping carts from store property, many existing shopping aids are not protected against unwanted removal. Another serious concern faced by retailers is the economic loss associated with lost or stolen shopping aids. To the extent a shopping aid includes a tablet or other display/user interface incorporated therein that is easily albeit destructively removable, theft or damaged shopping aid devices is a serious concern that often leads retailers to not adopt such systems.

What is also needed is a way to secure shopping aids to both kiosk and/or storage walls to prevent unwanted removal and loss. What is needed is a kiosk and shopping aid storage and dispensing configuration that takes up little floor space in stores. What is needed is a way to effectively and efficiently provide shopping aids to shoppers and to collect information pertaining to shopper use and identity associated with use of the shopping aids provided at the retail store.

### SUMMARY OF THE INVENTION

The present invention provides a system and related method for enhancing shopping and retailer experience in connection with brick-and-mortar grocery and other retail stores. At its core, the invention provides a way to removably attach shopping aids (CCDDs described in detail below) in a secure fashion by locking the devices on a shopping cart and at a kiosk charging station and providing a “key” means to unlock and release the devices for customer use in the store during shopping. The CCDD may then be secured to a shopping cart used by the shopper while shopping.

A kiosk is configured to house and charge a set of rechargeable cart-deployed communications and display devices (CCDDs) for use by shoppers, store associates, and third-party contractors securely and efficiently. One goal of the inventive system is to occupy as little floorspace as possible while housing and charging a sufficient number of CCDDs for anticipated shopper use and demand. The stacked arrangement of the kiosk contributes to achieving this goal.

The CCDDs are locked on the shopping carts and at the kiosk to prevent unwanted theft and damage and are released by either a mechanical key or an electronic key solution. The mechanical key may operate as a typical mechanical key with the CCDDs having a key receiving slot or opening or feature such that the key acts on a matingly configured locking/unlocking mechanism to dislodge the locking/unlocking mechanism and allow the CCDD to be removable from the kiosk and securely placed on a receiving CCDD support platform installed on the cart. The mechanical key may have a transponder or similar “handshaking” feature to provide a level of authentication or identification that the key is an authorized key for purposes of removing CCDDs. An optional electronic key may include a physical device, e.g., a smart phone, an RFID card or fob, an NFC device, a BLE (Bluetooth BT Low Energy) or BT device, facial or biometric identification device, etc. The electronic key serves to identify, authenticate, track, log or otherwise confirm acceptance of the user for unlocking the CCDD and allowing removal from the kiosk. The key may be administered by or with the assistance of a store employee, c.g., an employee co-located with the kiosk and having a lanyard or the like with the operative key or other means to unlock the CCDD for use by a shopper.

The kiosk and/or other means for identifying and tracking user usage of CCDDs may be included to aid in preventing theft or unwanted loss of the CCDDs. Also, after the shopper has finished shopping, the CCDD assigned to the user is returned, e.g., at a point-of-sale POS location or back to the kiosk. The kiosk(s) is/are preferably and conveniently located near the entrance(s) of the retail store. A further receptacle may be located near the POS or other location for logging and retrieving return of the CCDDs after shopper use. For example, the key mechanism may include a way to communicate a user identification signal and/or access a database to access a user profile record, such as administered by a retailer in connection with a frequent shopper or loyalty program. In this manner, the kiosk/CCDD system may be integrated with an existing retailer program to seamlessly incorporate tracking and other capabilities with known user profile databases and known product database. For example, each CCDD may include one or more of a scanner, e.g., bar code or machine-readable code device, camera(s), card reader, GPS, BT/BLE, NFC, devices to track cart location throughout a store. Location-based messaging may be provided and the CCDD system may access a store layout or map for an “awareness” of goods and other items of interest located throughout the store for purchase or use by the user/shopper.

The system may be used in connection with one or more Customer Loyalty or Registry Databases (“CLD”), which may take the exemplary form of one or more electronic, magnetic, or optical data-storage devices, and include or are otherwise associated with respective indices. Each of the indices includes terms and phrases in association with corresponding customer profiles, addresses, identifiers, and other conventional information. CLD databases may be cloud-based or coupled or accessed via a wireless or wireline communications network, such as a local-, wide-, private-, or virtual-private network, to a central server. accessible remotely. Customers may also be “subscribers” as in the case of COSTCO and Sam's Club or other retailers that require shoppers to have a subscription, although even non-paying customers at such stores as Krogers and the like do enroll in loyalty programs and are also “subscribers” as that term is used in this specification.

The CLD database may be a component of or associated with a master retailer or company-wide central server “Master Network” and may include customer or subscriber-related data for controlling, administering, and managing membership or subscription-based access of registry database(s). In the exemplary embodiment, subscriber database includes one or more user preference (or more generally user) data structures. In the exemplary embodiment, one or more aspects of the user data structure relate to user customization of various communication and interface options stored as user stored data. User data also includes user ID, subscription data, user preferences, and external user stored data. Master Network server may include one or more user-interface components, for receiving and processing data collection and processing in support of the loyalty program and other functions of store operation, including kiosk related functions.

In a first embodiment the invention provides a system for providing an enhanced shopping experience in a brick and mortar retail store facility, the system comprising: a kiosk having a first wall including a set of openings or slots adapted to receive a set of storing/charging holsters, a power source, and a display having a user interface; a set of rechargeable cart-deployed communications and display devices (CCDDs) for use by shoppers; wherein the CCDDs are operatively connected to the power supply when the CCDDs are disposed in respectively in the set of storing/charging holsters; and wherein each of the CCDDs and each of the storing/charging holsters include complementary locking/unlocking mechanisms to secure cach CCDD to a storing/charging holster, the complementary locking/unlocking mechanisms being operable to selectively unlock and remove the CCDDs from the kiosk for use by the shopper.

In addition, the invention of the first embodiment may be further characterized by one or more of the following features and enhancements: wherein the power source is connected to the set of storing/charging holsters; wherein the locking/unlocking mechanisms may be physical or a combination of physical and virtual or electronic components to allow authorized persons to unlock and remove the CCDD; wherein the kiosk is configured to securely and efficiently house and charge the CCDDs in a manner to limit spatial footprint or the kiosk, specifically, the openings and CCDDs are “stacked” in arrays to maximize or improve or optimize the storage capacity of the kiosk while limiting or minimizing the floorspace occupied by the kiosk in the retail store; wherein the complementary locking/unlocking mechanisms serve to lock CCDDs are locked at the kiosk to prevent unwanted theft and damage and are released by either of a mechanical key or an electronic key solution; wherein the locking/unlocking mechanism includes a mechanical key and the CCDDs include a key receiving slot or opening or feature configured to accept the mechanical key; and wherein the mechanical key when inserted into the CCDD key slot or opening acts on a matingly configured component of the locking/unlocking mechanism to release the release the CCDD from the storing/charging holster and allow the CCDD to be removed from the kiosk and wherein the CCDD may be securely placed on a receiving CCDD support platform installed on a shopping cart; wherein the mechanical key includes a transponder or similar “handshaking” feature to provide a level of authentication or identification that the key is an authorized key for purposes of removing CCDDs from the kiosk and/or the shopping cart; wherein the locking/unlocking mechanism is configured to operate in connection with an electronic key, which may include a physical device, e.g., a smart phone, an RFID card or fob, an NFC device, a BLE (Bluetooth BT Low Energy) or BT device, facial or biometric identification device, etc.; wherein the electronic key serves to identify, authenticate, track, log or otherwise confirm acceptance of the user for unlocking the CCDD and allowing removal from the kiosk; wherein the key may be administered by or with the assistance of a store employee, e.g., an employee co-located with the kiosk and having a lanyard or the like with the operative key or other means to unlock the CCDD for use by a shopper; wherein the kiosk and/or other means for identifying and tracking user usage of CCDDs may be included to aid in preventing theft or unwanted loss of the CCDDs; further comprising a second kiosk or other receiving unit located at or near a second location, e.g., at a point-of-sale POS location, for detaching the CCDD from a shopping cart and collecting returned CCDDs; wherein kiosk is preferably and conveniently located near an entrance of the retail store and near the shopping cart storage area; wherein the kiosk and/or second kiosk includes a means for logging and return of CCDDs after shopper use; wherein the key mechanism includes a way to communicate a user identification signal and/or access a database to access a user profile record, such as administered by a retailer in connection with a frequent shopper or loyalty program; wherein the kiosk/CCDD system may be integrated with an existing retailer program to seamlessly incorporate tracking and other capabilities with known user profile databases and known product database; wherein the CCDDs include one or more of a scanner, e.g., bar code or machine-readable code device, camera(s), card reader, GPS, BT/BLE, NFC, devices to track cart location throughout a store; further comprising location-based messaging for display at the CCDD; wherein the CCDDs may access a store layout or map for an “awareness” of goods and other items of interest located throughout the store for purchase or use by the user/shopper.

Exemplary embodiments of the present invention are provided in more detail below.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 is a schematic diagram of the Enhanced Shopping Experience System 100 components involved in a first embodiment of the invention.

FIGS. 2A and 2B are schematic diagrams showing an exemplary Kiosk 200 component according to the present invention.

FIGS. 3A and 3B are perspective detailed views of the Kiosk CCDD holster component having a CCDD disposed therein in connection with the first embodiment of the present invention.

FIGS. 4A and 4B are perspective detailed views of the mobile shopping aid CCDD component associated with the first embodiment of the present invention.

FIGS. 5A-5C are a series of schematic views of the shopping cart attachment and CCDD support component of the present invention with a CCDD (FIG. 5C) shown disposed on the support in connection with the first embodiment of the present invention.

FIGS. 6A and 6B are side cross-sectional detailed views of the Kiosk CCDD holster component having a CCDD disposed therein and highlighting the locking features in connection with the first embodiment of the present invention.

FIGS. 7A-7D are a series of perspective views of the CCDD shopping-cart aid component in connection with the first embodiment of the present invention.

FIGS. 8A-8E are a series of perspective views of a Key and the CCDD components related to the locking solution provided in connection with the first embodiment of the present invention.

FIGS. 9A-9C are a series of detailed side and perspective views of the Kiosk CCDD holster component in connection with the first embodiment of the present invention.

FIG. 10 is a schematic diagram showing an exemplary Kiosk 200 component according to the present invention.

### DETAILED DESCRIPTION OF THE INVENTION

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

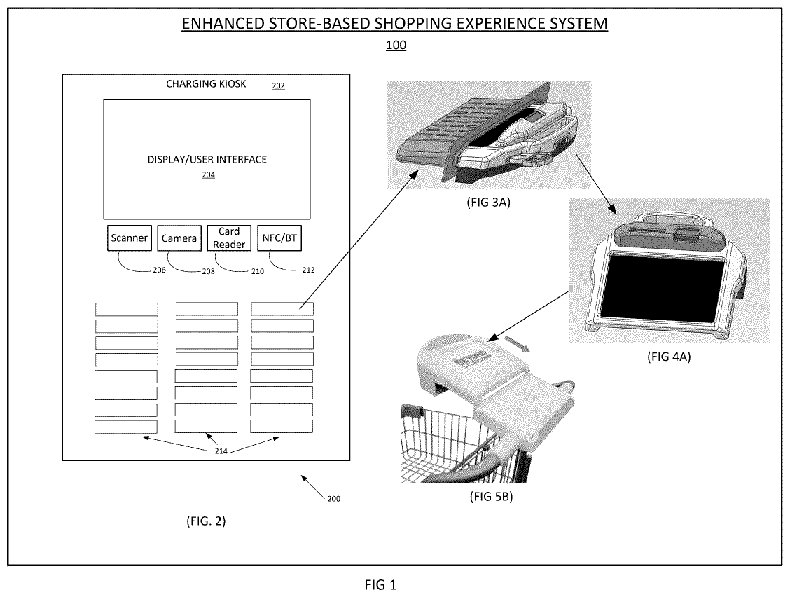

As shown in FIG. 1, Enhanced Shopping Experience System 100 includes a charging kiosk station 200 from which are stored and distributed a set of cart-placed CCDDs, described below, which are removed from the Kiosk 202 and removably installed on a support member 302 affixed on a shopping cart 350 for use by a shopper during a shopping experience in a store. The Charging Kiosk station 200 comprises a charging Kiosk 202, a display 204, a scanner 206, a camera 208, a card reader 210, a NFC/BT feature 212, and a set of storing/charging holsters or charging cells 214. The CCDDs are designed to be relatively small in size, about the size of a small tablet encased in a secure housing with peripheral components, c.g., scanner, imaging or camera devices. A Key or other locking means secures the CCDD to the storing/charging holster and the kiosk until unlocked and removed from the kiosk, it is then secured to the shopping cart until unlocked for safekeeping after use.

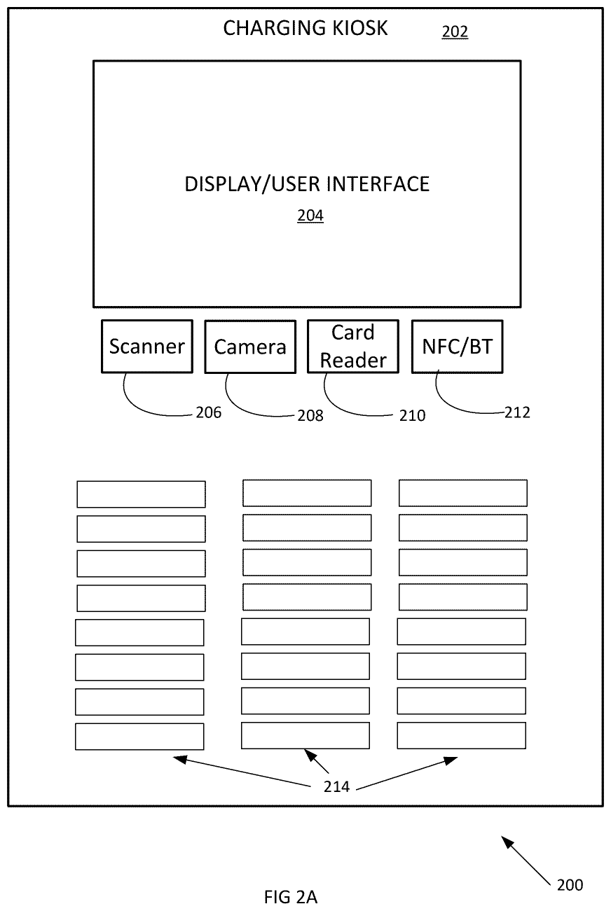

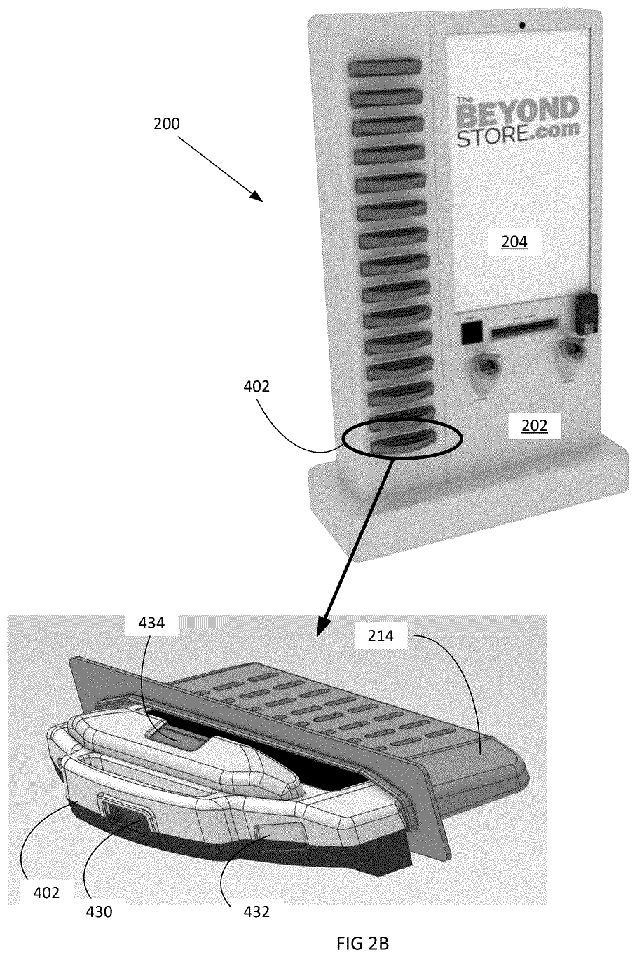

Now referring to FIGS. 2A-2B, an exemplary embodiment of Kiosk-based Rechargeable Cart Device Facility 200 provides a compact means for storing and distributing in a secure manner shopping aids for enhancing shopping experience and for facilitating and increasing sales and affinity or loyalty participation. A charging Kiosk 202, for example, may include a computer (not shown) or processor-based controller or the like including one or more processors, memory devices, storage device, wireless communication capability, e.g., Bluetooth, cell, WLAN, Wi-Fi, Ethernet, for connecting the kiosk 202 to a store-based network and/or a remote server associated with one or more data management systems associated with a retailer or grocery, e.g., Kroger, Menards, Giant, Target, Costco, SAMs Club, etc. In this manner data may be collected locally at the kiosk or in connection with usage of the CCDDs 402 and may be shared with local or remote systems for use in maintaining user profile records, loyalty programs, inventory management, maintenance of the CCDDs (e.g., charge levels, component functioning), store statistics. Although shown as a stand-alone unit, the “kiosk” may alternatively be incorporated into a wall structure or other structural feature of the store for storing and charging, distributing, and maintaining the CCDD devices.

As shown in FIGS. 2A-2B, the kiosk 202 includes a Kiosk Display and User Interface, e.g., touchscreen 204. The kiosk 202 may include a scanner 206, e.g., machine readable code scanner, facial recognition, loyalty program fob reader, electronic signal scanner, c.g., RFID, NFC, BT. The kiosk 202 may include a camera 208, e.g., for capturing images, facial recognition, other optical recognition. The kiosk 202 may include a card reader 210, e.g., loyalty program card, chip reader, other NFC capability reader. The kiosk 202 may include a NFC (Near Field Communication) and/of Bluetooth or BLE (BT low energy) type interface device 212.

The kiosk 202 includes a dense and compact “stacked” array or set of CCDD receptacles and storing/charging holsters “Charging Cells” or “storing/charging holsters” 214. By densely stacking the array of holsters and CCDDs the kiosk configuration takes up a reduced or minimal floorspace. Floorspace at retail stores is critical as it relates directly to available space for produce and goods and therefore revenue potential for the store. The kiosk 202 includes one or more arrays of Storing/charging holsters 214 for securely storing and dispensing a set of CCDDs 402. Each of the Storing/charging holsters 214 includes a battery charger or charging interface component 240 that is connected to a main Kiosk power source 216 to maintain a level of charge for the associated CCDD 402. Each CCDD includes a power source, c.g., a rechargeable battery. In one instance the CCDD battery includes a set of contacts or leads 422 that communicate energy or power or current to the CCDD battery. Inductive charging may also be used to charge the CCDD 402. The storing/charging holsters 214 include a locking/unlocking mechanism to prevent unauthorized removal of CCDDs placed therein. In one manner of operation a store representative or employee has a key configured to operate a lock to free the CCDD from the storing/charging holster for use by a shopper and placement on a shopping cart. In another manner of operation, a user may unlock a CCDD from a storing/charging holster by a facial recognition feature of the Kiosk, a card reader of the Kiosk, a scanner or other means, such as recognizing the user as a member of a store loyalty program or other user profile. In this manner the Kiosk and/or CCDD may be used to associate a CCDD with a known user and tracked through use of the CCDD at the store and return, e.g., at a point-of-sale POS at the store. At the POS, such as during check-out, the user or store personnel may unlock the CCDD from the cart and place in a bin for return to the Kiosk or other means for maintaining the inventory of CCDDs. For instance, a pair of Kiosks may be maintained at a store and may be on casters or wheels or otherwise transportable for rotation of the units from one location to another within the store.

In operation, a user or store representative unlocks the CCDD 402 and removes it from the storing/charging holster 214 and the kiosk 202. The CCDD 402 may then be installed on the CCDD support device 302 and secured to a cart 350 for use during shopping.

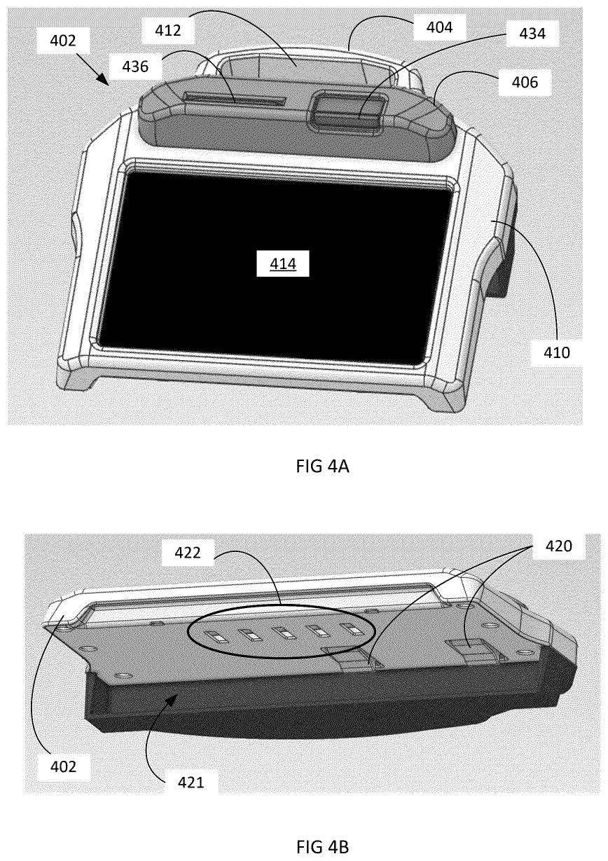

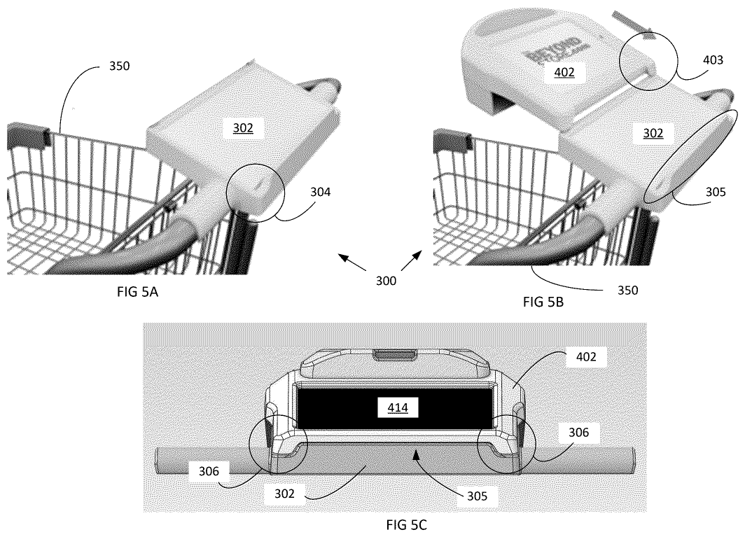

As shown in FIGS. 5A-5C, cart 350 includes a handle to which is attached a Cart Handle Fixture/Frame or CCDD support device 302. Preferably the support 302 is relatively compact and occupies about or no more than the area of a CCDD, which, again, is about the size of a small tablet with surrounding protective housing (see FIG. 4A). The CCDD support 302 is adapted or configured to removably and fixably receive and secure CCDD 402. The Cart Handle Fixture in one manner includes a recess 304 configured to permit attachment to a handle of the cart 350 and is removably secured to a shopping cart 350 for use by users or shoppers during shopping in the retail store. A latch or the like is provided on the CCDD and mating latch component on the Cart Fixture 302, which although shown mounted on a handle of the cart may be located or fixed to the cart in an alternative fashion. Preferably, the CCDD 402 is mounted onto the fixture 302 such that the CCDD display 414 faces or is within easy viewing of the shopper. Also the handle of the CCDD includes a cell phone or personal device holder to promote use and viewing of the display of the mobile device when placed in the handle of the CCDD. Shopping Cart 350 may be a traditional shopping cart and the CCDDs 402 are adapted to be received onto a cart support device 302 affixed to the cart 350. The support 302 is configured and placed on the handle to promote efficient stacking or nested storage of shopping carts. The support is also configured so that the ledge 305 provides a dual function of providing support for a CCDD placed on the support and also a support for a mobile device when a CCDD is not affixed to the shopping cart. In this manner, the ledge 305 allows a user to place a mobile device in a desired position for ease of use and view.

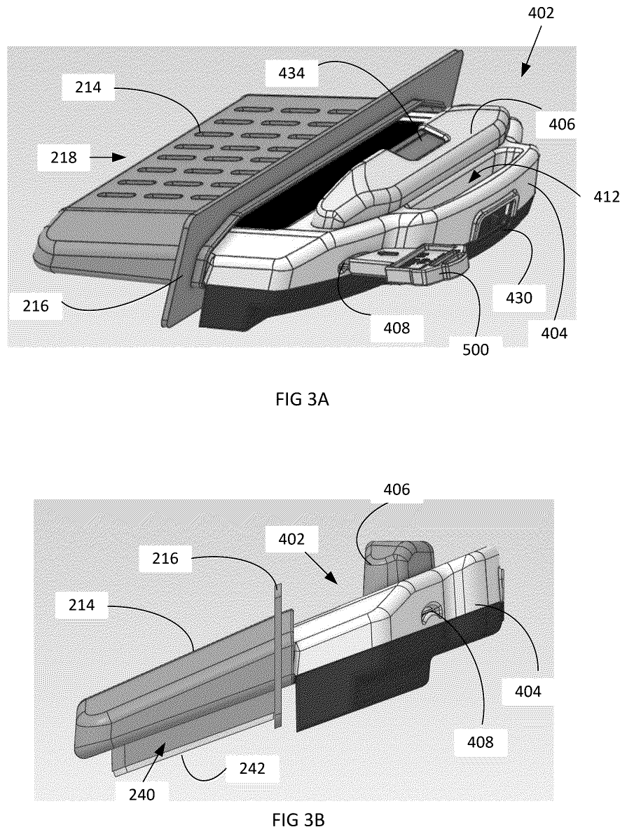

Referring now to FIGS. 3A-3C, CCDD 402 is shown in the form of a rechargeable Cart-deployed Communications and Display Device (CCDD). In the exemplary configuration shown, the CCDD 402 includes CCDD Handle portion 404, CCDD Peripheral Electronics Housing 406, CCDD Key Slot or receiving opening 408, CCDD Main Housing Body 410, CCDD Cell Phone Holder 412, CCDD Display 414, e.g., touchscreen, CCDD Lower Housing Body 416, interconnection cavity 418 for use in connecting or mounting the CCDD with the storing/charging holster 214 for storage and charging and with the cart support 302 during shopping operation. One advantage of having a mobile device storage or support 412 in the handle 404 is to provide a dual use of the physical structure to help minimize size and provide a more efficient shopping aid device.

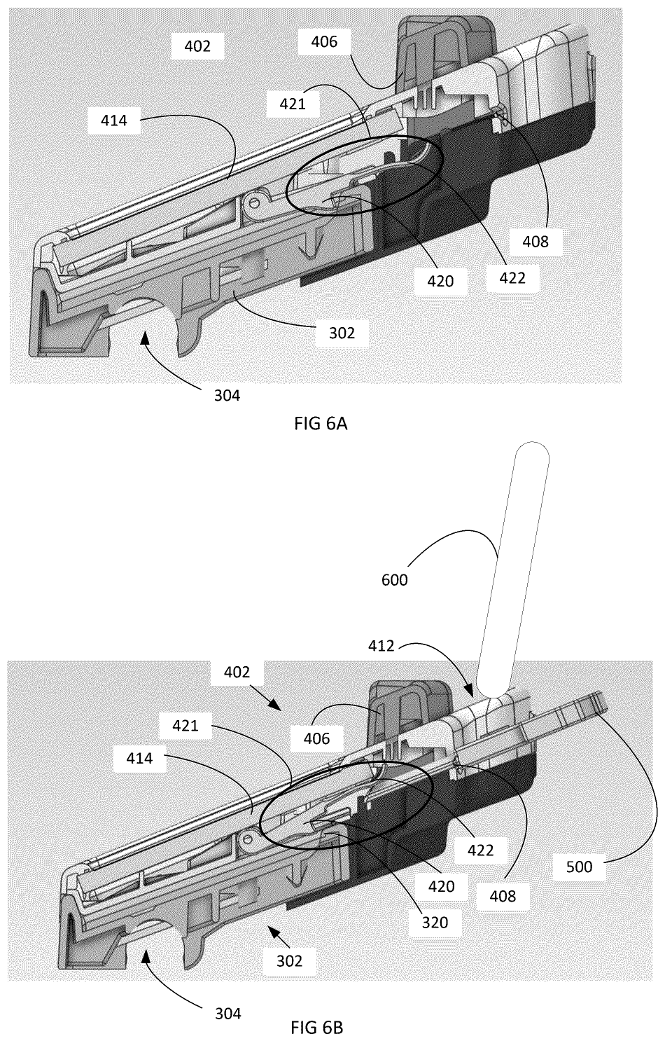

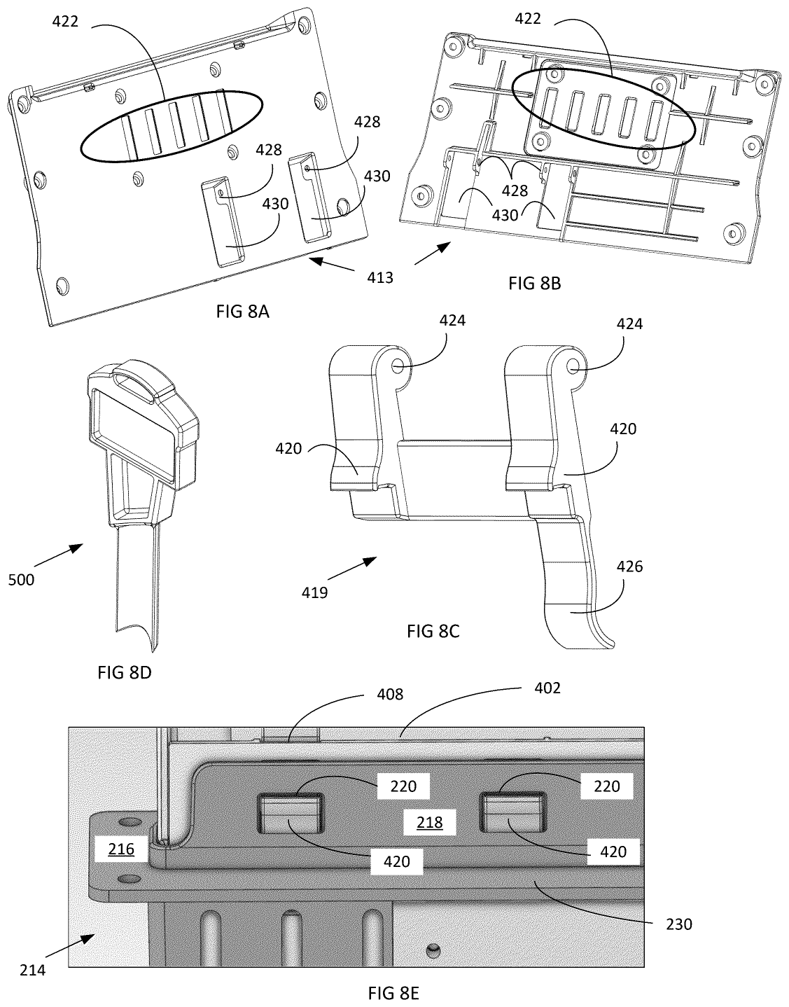

Locking/unlocking mechanism 419 includes Locking Tabs or Members 420 and are used to secure the CCDD alternately with the storing/charging holster 214 and CCDD support 302 and are received in mating latch or lock counterpart component (see highlighted area 421 in FIG. 6A and tab receiving ledge or opening 220 in FIG. 8E). A CCDD power source set of leads or contacts or interface 422 is provided to communicate power to the CCDD device. The CCDD may include a Forward Facing Camera 430, CCDD-One dimensional (1D) and/or 2D Scanner 434, and CCDD Card reader 436, e.g., Credit Card/Wireless Payment Reader.

As shown in FIG. 3A, a Key device 500, shown as a mechanical device configured to be received into the key hole or aperture or opening or slot 408, is adapted to contact the latching mechanism 420, to release the CCDD 402 from the Chargin Cell 214 when in the Kiosk 202, or from the support device 302 when installed on the shopping cart 350. Again, alternatively, the key 500 may be an electronic or signal based key to establish the user as authorized to access the CCDD 402.

Referring now to FIGS. 4A-4B, CCDD 402 is shown in a front perspective view (FIG. 4A) and a bottom-up view (FIG. 4B) to illustrate the display 414, latch mechanism tabs 420 of latching mechanism 419, and battery contact 422 features of the device. Also shown are the mobile phone or device holder 412, card reader 436, and scanner 434.

FIGS. 5A-5C illustrate the CCDD support 302 affixed to the handlebar of the shopping cart 350 with the process of placing and securing the CCDD 402 to the cart 350. As shown, CCDD support 302 includes a pair of notches or indentations 304 configured to matingly receive corresponding protuberances 403 on CCDD 402 such that when the CCDD is slidingly received onto the support 302, the notches and protuberances align and fit in place to create a joint or fit shown in the highlighted area 306 in FIG. 5C. By securing the CCDD 402 device to the support 302 and cart 350, as shown in FIG. 5C, the housing of main body 410 and lower body 416 prevents users from easily removing a tablet or the like associated with display 414. The communications components discussed herein in the context of the CCDD device, may be integral with a tablet or like device that serves as the core functional component of the CCDD. In this manner, store personnel may disassemble a CCDD to remove and replace a damaged display/tablet 414 and redeploy the CCDD for use by shoppers.

Referring now to FIGS. 6A-6B, a cross-section of the CCDD 402 combined or installed on the CCDD support 302 is shown to illustrate internal features of the devices. CCDD 402 is secured to the support component 302 in conjunction with a latching combination of articulating latch 419 with latch tabs or members 420 and a notch or opening or ledge 320 included on the support 302 whereby when the CCDD 402 is slidingly placed or positioned on the support 302 the latch mechanism 419 mechanically engages with the corresponding shoulder or ledge 320. In operation, a key 500 is inserted into opening 408 to allow the front portion or leading edge of the key to engage and displace curved feature 422 causing the latch mechanism tabs 420 to raise and disengage with shoulder or ledge 320 and free CCDD 402 from the support 302. As shown in FIG. 6B, a mobile device, e.g., a Smartphone, is received into opening or slot or well 412 and is supported by the mechanical walls formed in the handle 404 (404A/404B) of the body members 410 and 416. The well 412 is configured to receive sufficient portion of the mobile device to enable gripping or frictional engagement within the well and to provide sufficient exposure of the screen included on the mobile device to allow the user or shopper to view the screen and read content displayed thereon and to operate icons or virtual buttons to navigate. For example, a shopper may have a shopping list open and displayed on the screen of the mobile device. Also, the mobile device may be paired, e.g., Bluetooth, with the CCDD 402 to share information between the devices. For example, when attempting to scan large items, such as large bags of dogfood, cases of drinks, then the shopper may use the camera of the mobile device to scan the bar code on such large items and communicate the scanned item and information to the CCDD for use during checking out. In this manner the CCDD 402, in combination with a mobile device or not, transforms a “dumb” shopping cart into a “smart-cart” for enhanced shopping experience.

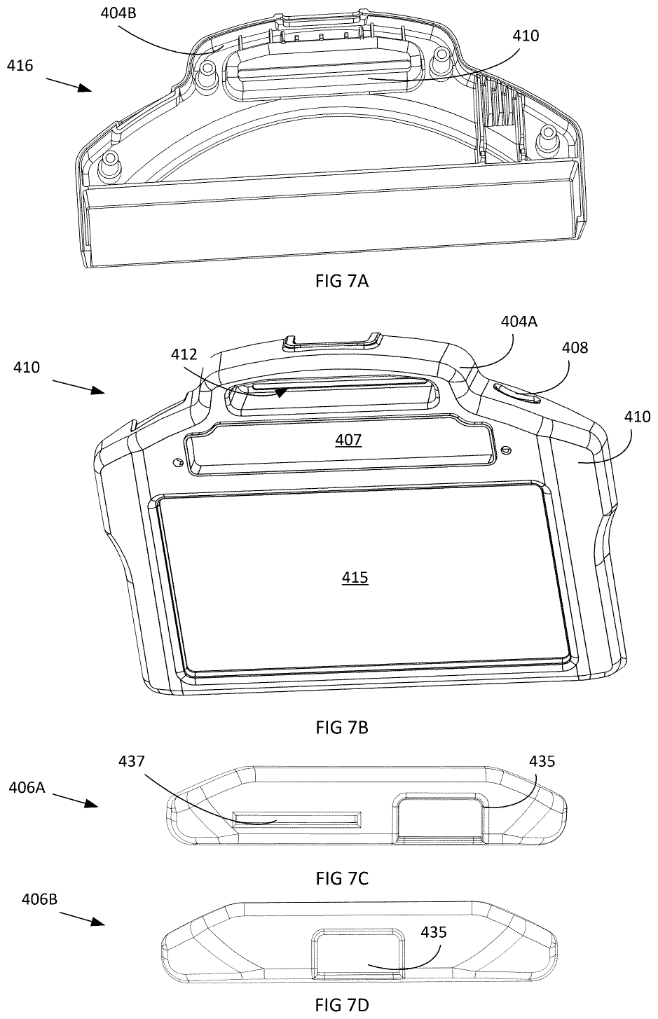

With reference to FIGS. 7A-7D, CCDD 402 includes an alternative CCDD Peripheral Electronics Housing 406 (see 406A and 406B of FIGS. 7C and 7D) that receive and support and include components such as scanner 434 and card reader 436. Openings or areas 437 and 435 are formed in the peripheral housing 406 to accommodate those components. CCDD Peripheral Electronics Housing 406 may be configured to provide an exchangeable hardware casing allowing for interchangeable peripheral devices. For example, cach compartment or opening or space in the CCDD Peripheral Electronics Housing 406 may be beneficially configured to receive and support and attach various components to tailor the particular needs of the retailer. Complementary hardware/electrical connections may be included to achieve desired compatibility and versatility.

CCDD Key Slot or receiving opening 408 is configured to receive a correspondingly and matingly configured key 500 for proper disposing within and through the opening. A CCDD Main Housing Body 410 is in this example the outwardly exposed portion of the CCDD and includes an opening or area 415 for exposing a display 414 for viewing by the user when the CCDD is installed on the shopping cart 350. CCDD Cell Phone Holder 412 and corresponding opening 407 of the main housing body 410 allows a user's phone to be placed on the CCDD 402 for viewing and use by the shopper. CCDD Display 414, e.g., touchscreen, is configured to be viewed by the user. CCDD Lower Housing Body 416 combines with the main housing body 410 to enclose various components of the CCDD 402. An interconnection cavity 418 is provided for use in connection with the storing/charging holster 214 and cart support 302 to mechanically interlock the CCDD with those devices. Handle 404 is made up of handle portions 404A and 404B respectively of the main body 410 and lower body 416.

As shown in FIGS. 8A-8E, as part of the exemplary locking/unlocking mechanism component of the CCDD 402, latch mechanism 419 (FIG. 8C) includes locking Tabs or Members 420 and pivot points 424 with key lever 426 for disengaging the latch mechanism when key 500 (FIG. 8D) is disposed in and through opening 408. The locking mechanisms are preferably designed to occupy little space to minimize the size of the holster 214 and housing 410/416. FIGS. 8A and 8B illustrate a bottom plate 423 having a series of slots or openings 422 through which connectors or contacts are disposed for connecting the CCDD battery with a power source on the Kiosk 202. The bottom plate includes openings 430 through which the locking tabs 420 are disposed and have complementary pins or receiving arms 428 to receive the pivots 424. FIG. 8E illustrates the tabs 420 received into the openings 220 of the storing/charging holster 214 for locking the CCDD 402 in place within the storing/charging holster when placed in the kiosk 202 for charging. CCDD power source leads or contacts or interface 422. The CCDD 402 includes, in one embodiment, forward facing Camera 430, CCDD One dimensional (1D) and/or 2D Scanner 434, and CCDD Card reader 436, e.g., Credit Card/Wireless Payment Reader.

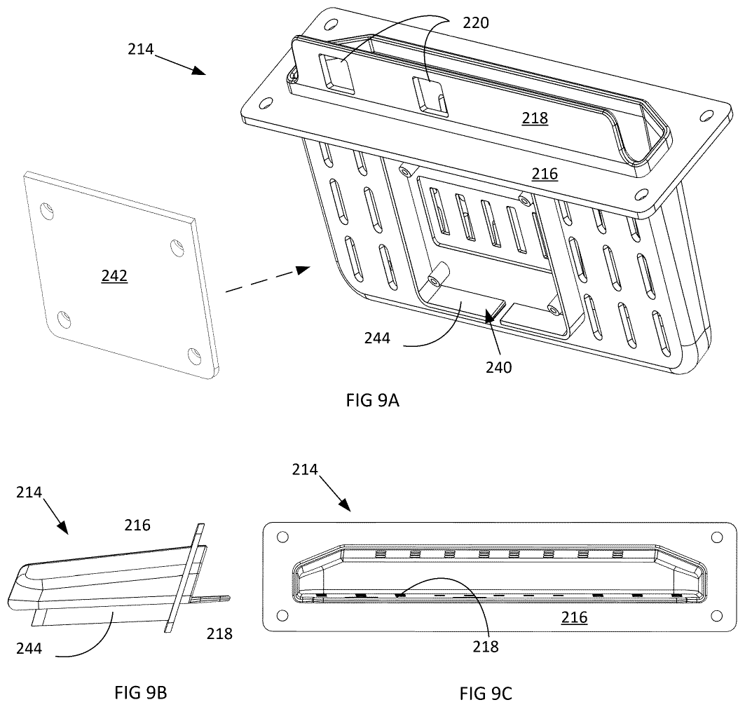

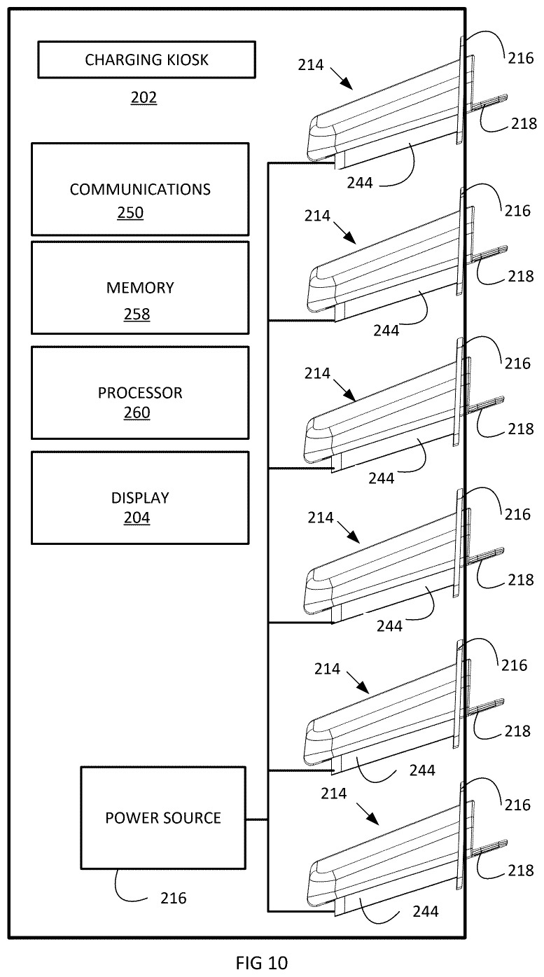

An exemplary embodiment of the storing/charging holster 214 is shown in FIGS. 9A-9C with front plate 216 configured to abut an interior panel of the kiosk 202, as shown in FIG. 10, and a ledge 218 for supporting the CCDD 402 when placed in the cell 214. Ledge 218 includes latch counterpart notches or openings 220 that form mechanical catches to engage with latch mechanism tabs 420 as shown in FIG. 8E. Rectangular side wall 244 forms an interior space 240 for receiving and supporting a battery or charging interface for charging the CCDD 402 when placed in the cell 214 and the kiosk 202. A removable cover 242 is used to protect the battery or charging interface device (not shown) and to keep it in position when installed in the receiving area 240. The battery charging interface device is placed in the receiving area 420 so that a set of contacts or leads or the like are positioned to match up with a battery or power unit of the CCDD 402 installed in the storing/charging holster 214. As shown, a set of slits or openings 422 are provided in the back plate 423 to allow the battery charging device to contact the corresponding power unit of the CCDD 402 when it is placed in the kiosk for charging. The battery charging device may be removed and replaced by removing the cover 242 and disconnecting the device from the kiosk power source.

FIG. 10 illustrates a kiosk 202 with a power source 216 connected to the battery or charging interface components disposed within spaces 240 defined by walls 244 and cover 242 within storing/charging holsters 214. Kiosk may include software-based applications including non-volatile memory and instructions for accessing and executing by processor 260. A communications module 250 may include one or more wireless and/or wired communications components, including for example: WLAN, Ethernet, NFC, BT, BLE, RFID, Wi-Fi components or features. The wireless or wired communications componentry 250 may connect, via one or more communications networks (e.g., Internet or intranet) with store-based systems, central server facilities, and third-party systems. One example of a third-party system is an outside provider of the enhanced shopping experience system. That is the provider of the kiosk may be an entity separate from the retailer and may lease and maintain the kiosks and CCDDs and other related equipment to fit out a store-based solution.

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

What is claimed is:

1. A system for providing an enhanced shopping experience in a brick and mortar retail store facility, the system comprising:
a kiosk having a first wall including a set of openings or slots adapted to receive a set of storing/charging holsters, a power source, and a display having a user interface;
a set of rechargeable cart-deployed communications and display devices (CCDDs) for use by shoppers;
wherein the CCDDs are operatively connected to the power supply when the CCDDs are disposed in respectively in the set of storing/charging holsters; and wherein each of the CCDDs and each of the storing/charging holsters include complementary locking/unlocking mechanisms to secure each CCDD to a storing/charging holster, the complementary locking/unlocking mechanisms being operable to selectively unlock and remove the CCDDs from the kiosk for use by the shopper.

2. The system of claim 1, wherein the power source is connected to the set of storing/charging holsters.

3. The system of claim 1, wherein the locking/unlocking mechanisms may be physical or a combination of physical and virtual or electronic components to allow authorized persons to unlock and remove the CCDD.

4. The system of claim 1, wherein the kiosk is configured to securely and efficiently house and charge the CCDDs in a manner to limit spatial footprint or the kiosk, specifically, the openings and CCDDs are “stacked” in arrays to maximize or improve or optimize the storage capacity of the kiosk while limiting or minimizing the floorspace occupied by the kiosk in the retail store.

5. The system of claim 1, wherein the complementary locking/unlocking mechanisms serve to lock CCDDs are locked at the kiosk to prevent unwanted theft and damage and are released by either of a mechanical key or an electronic key solution.

6. The system of claim 1, wherein the locking/unlocking mechanism includes a mechanical key and the CCDDs include a key receiving slot or opening or feature configured to accept the mechanical key; and wherein the mechanical key when inserted into the CCDD key slot or opening acts on a matingly configured component of the locking/unlocking mechanism to release the release the CCDD from the storing/charging holster and allow the CCDD to be removed from the kiosk and wherein the CCDD may be securely placed on a receiving CCDD support platform installed on a shopping cart.

7. The system of claim 1, wherein the mechanical key includes a transponder or similar “handshaking” feature to provide a level of authentication or identification that the key is an authorized key for purposes of removing CCDDs from the kiosk and/or the shopping cart.

8. The system of claim 1, wherein the locking/unlocking mechanism is configured to operate in connection with an electronic key, which may include a physical device, e.g., a smart phone, an RFID card or fob, an NFC device, a BLE (Bluetooth BT Low Energy) or BT device, facial or biometric identification device.

9. The system of claim 1, wherein the electronic key serves to identify, authenticate, track, log or otherwise confirm acceptance of the user for unlocking the CCDD and allowing removal from the kiosk.

10. The system of claim 1, wherein the key may be administered by or with the assistance of a store employee, e.g., an employee co-located with the kiosk and having a lanyard or the like with the operative key or other means to unlock the CCDD for use by a shopper.

11. The system of claim 1, wherein the kiosk and/or other means for identifying and tracking user usage of CCDDs may be included to aid in preventing theft or unwanted loss of the CCDDs.

12. The system of claim 1 further comprising a second kiosk or other receiving unit located at or near a second location, e.g., at a point-of-sale POS location, for detaching the CCDD from a shopping cart and collecting returned CCDDs; wherein kiosk is preferably and conveniently located near an entrance of the retail store and near the shopping cart storage area.

13. The system of claim 1, wherein the kiosk and/or second kiosk includes a means for logging and return of CCDDs after shopper use; wherein the key mechanism includes a way to communicate a user identification signal and/or access a database to access a user profile record, such as administered by a retailer in connection with a frequent shopper or loyalty program.

14. The system of claim 1, wherein the kiosk/CCDD system may be integrated with an existing retailer program to seamlessly incorporate tracking and other capabilities with known user profile databases and known product database.

15. The system of claim 1, wherein the CCDDs include one or more of a scanner, e.g., bar code or machine-readable code device, camera(s), card reader, GPS, BT/BLE, NFC, devices to track cart location throughout a store; further comprising location-based messaging for display at the CCDD; wherein the CCDDs may access a store layout or map for an “awareness” of goods and other items of interest located throughout the store for purchase or use by the user/shopper.
